(19) United States
(12) Patent Application Publication
(10) Pub. No.: US 2021/0095977 A1
(43) Pub. Date: Apr. 1, 2021

(54) REVISING SELF-DRIVING VEHICLE ROUTES IN RESPONSE TO OBSTRUCTIONS

(71) Applicant: UATC, LLC, San Francisco, CA (US)

(72) Inventors: Shenglong Gao, San Francisco, CA (US); Jacob Robert Forster, San Francisco, CA (US); Mark Yen, San Francisco, CA (US); Alan B. Sheinberg, San Francisco, CA (US)

(21) Appl. No.: 16/948,822

(22) Filed: Oct. 1, 2020

Related U.S. Application Data
(60) Provisional application No. 62/909,019, filed on Oct. 1, 2019.

(51) Int. Cl. G01C 21/34; G08G 1/0968; G08G 1/0967

(52) U.S. Cl. CPC G01C 21/3415; G08G 1/096725; G08G 1/096844; G01C 21/3492

(57) ABSTRACT

Various examples are directed to systems and methods for controlling a self-driving vehicle. A computing device may cause the self-driving vehicle to begin traversing a route. The computing device may detect that the self-driving vehicle is approaching an obstruction and determine to take a deviating maneuver to a revised route prior to the obstruction. The computing device may cause the self-driving vehicle to take the deviating maneuver and cause the self-driving vehicle to execute a revised route, the revised route including the deviating maneuver.

### CLAIM FOR PRIORITY

This application claims the benefit of priority of U.S. Application Ser. No. 62/909,019, filed Oct. 1, 2019, which is hereby incorporated by reference in its entirety.

### FIELD

This document pertains generally, but not by way of limitation, to devices, systems, and methods for operating a self-driving vehicle (SDV).

### BACKGROUND

A SDV is a vehicle that is capable of sensing its environment and operating some or all of the vehicle's controls based on the sensed environment. A self-driving vehicle includes sensors that capture signals describing the environment surrounding the vehicle. The self-driving vehicle processes the captured sensor signals to comprehend the environment and automatically operates some or all of the vehicle's controls based on the resulting information.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment for routing a self-driving vehicle.

FIG. 2 depicts a block diagram of an example vehicle, according to example aspects of the present disclosure.

FIG. 3 is a flowchart showing one example of a process flow that may be executed by the vehicle autonomy system to detect and respond to an obstruction on an initial route.

FIG. 4 is a flowchart showing one example of a process flow that may be executed by the vehicle autonomy system when approaching an intersection between two roadways where a traffic signal could generate an obstruction.

FIG. 5 is a flowchart showing another example of a process flow that may be executed by the vehicle autonomy system when approaching an intersection between two roadways where a traffic signal could generate an obstruction.

FIG. 6 is a diagram that illustrates an example deviating maneuver executed by an SDV.

FIG. 7 is a diagram that illustrates other example deviating maneuvers executed by an SDV.

FIG. 8 is a block diagram showing one example of a software architecture for a computing device.

FIG. 9 is a block diagram illustrating a computing device hardware architecture.

### DESCRIPTION

Examples described herein are directed to systems and methods for routing an SDV. Various examples described herein are directed to systems and methods for revising an SDV route in response to a roadway obstruction, such as a traffic signal indicating a stop instruction along the SDV's direction of travel.

In an SDV, a vehicle autonomy system, sometimes referred to as an AV stack, controls one or more of braking, steering, or throttle of the SDV. An SDV can be fully autonomous or semi-autonomous. In a fully autonomous vehicle, the vehicle autonomy system assumes full control of the vehicle. In a semi-autonomous vehicle, the vehicle autonomy system assumes a portion of the vehicle control, with a human user (e.g., a vehicle operator) still providing some control input. Some SDVs can operate in different modes where one or more modes involve fully autonomous operation and one or more modes involve semi-autonomous operation. Also, some SDVs can also operate in a manual mode, in which a human user provides all control inputs to the vehicle.

A vehicle autonomy system can control an SDV along a route. A route is a path that the SDV takes, or plans to take, over one or more roadways. The route for an SDV is generated by a routing engine, which can be implemented onboard the SDV or offboard the SDV. The routing engine can be programmed to generate routes that optimize the time, danger, and/or other factors associated with driving on the roadways.

In various examples, it is desirable to configure a routing engine to cope with roadway conditions, vehicle capabilities, and sometimes even business policy preferences. For example, if a portion of a roadway is closed for construction, it is desirable that the routing engine avoid routing the SDV through graph elements that correspond to the closed portion. Also, it is desirable that the routing engine avoid routing an SDV through graph elements that include maneuvers that the SDV is not capable of making. Further, it may be desirable for the routing engine to avoid routing SDVs through graph elements selected according to business policies, such as, for example, graph elements corresponding to roadway segments that are in school zones.

Factors that are known by the routing engine, such as business policy preferences, vehicle capabilities, and some roadway conditions, can be accounted for when a route is generated. For example, the routing engine may generate and/or apply a constrained routing graph, where the constrained routing group modifies the cost and/or connectivity of graph elements to reflect the known factors.

Sometimes, however, the SDV encounters obstructions that were not known to the routing engine. These obstructions can include, for example, a traffic signal indicating a stop instruction for traffic along the SDV's direction of travel, an unexpected traffic condition, a disabled vehicle, and so forth. When such an obstruction is encountered, the SDV's progress on the route is delayed. For example, if a traffic signal indicates a stop instruction, the SDV stops until the traffic signal changes. If an unexpected traffic obstruction occurs, the SDV slows down or even stops until the obstruction is cleared.

Various examples described herein are directed to SDVs and methods of operating SDVs that consider making a deviating maneuver to a revised route when an obstruction is encountered. The vehicle autonomy system accesses route data describing an initial route for the SDV to execute. The route data can be generated by an onboard routing engine and/or provided from a remote source such as a transportation service system that arranges for the SDV to provide transportation services. The initial route has a route start point and a route end point. Sometimes the initial route also has one or more waypoints. The vehicle autonomy system causes the SDV to traverse the initial route, as described in more detail herein.

While the SDV is traversing the initial route, the vehicle autonomy system determines that the SDV is approaching an obstruction, such as a traffic signal instructing the SDV to stop. The vehicle autonomy system considers whether to stay on the route or to make a deviating maneuver to a revised route. The deviating maneuver can include executing a turn (e.g., from one roadway to another) or continuing to proceed straight, for example, at a roadway intersection where the initial route called for a turn. The vehicle autonomy system makes the deviating maneuver, for example, if proceeding straight reduces the SDVs time-to-target.

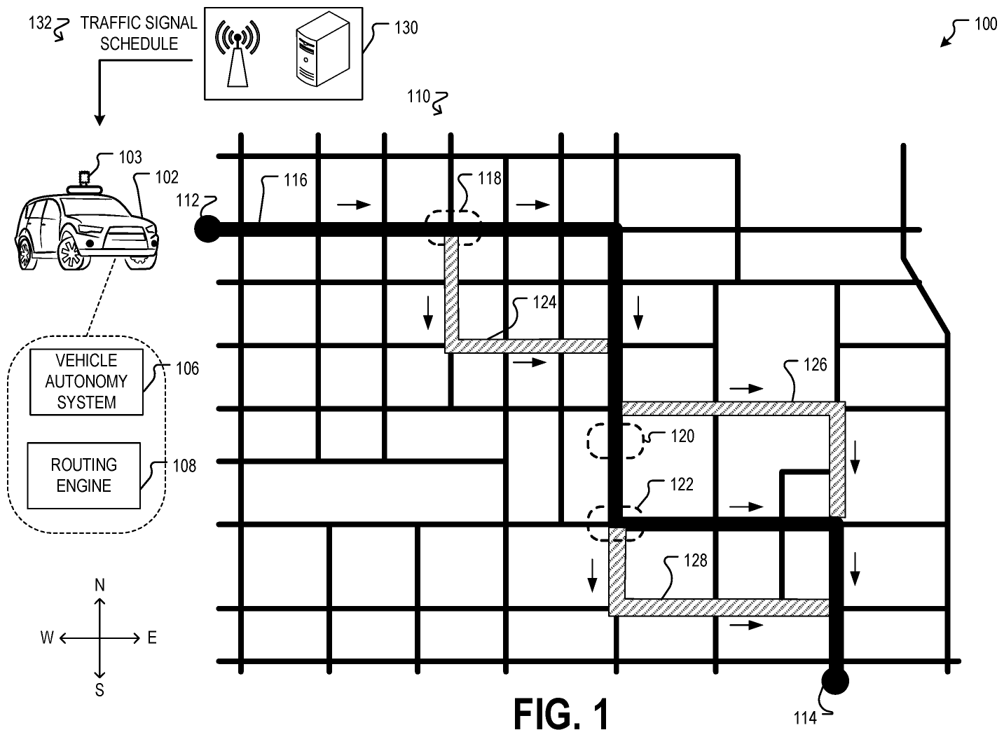

FIG. 1 is a diagram showing one example of an environment 100 for routing an SDV. The environment 100 includes an SDV 102. The SDV 102 can be a passenger vehicle such as a car, a truck, a bus, or another similar vehicle. The SDV 102 can also be a delivery vehicle, such as a van, a truck, a tractor trailer, and so forth. The SDV 102 is self-driving and, in some examples, is referred to as an autonomous vehicle (AV). The SDV 102 includes a vehicle autonomy system 106 that is configured to operate some or all of the controls of the SDV 102 (e.g., acceleration, braking, steering).

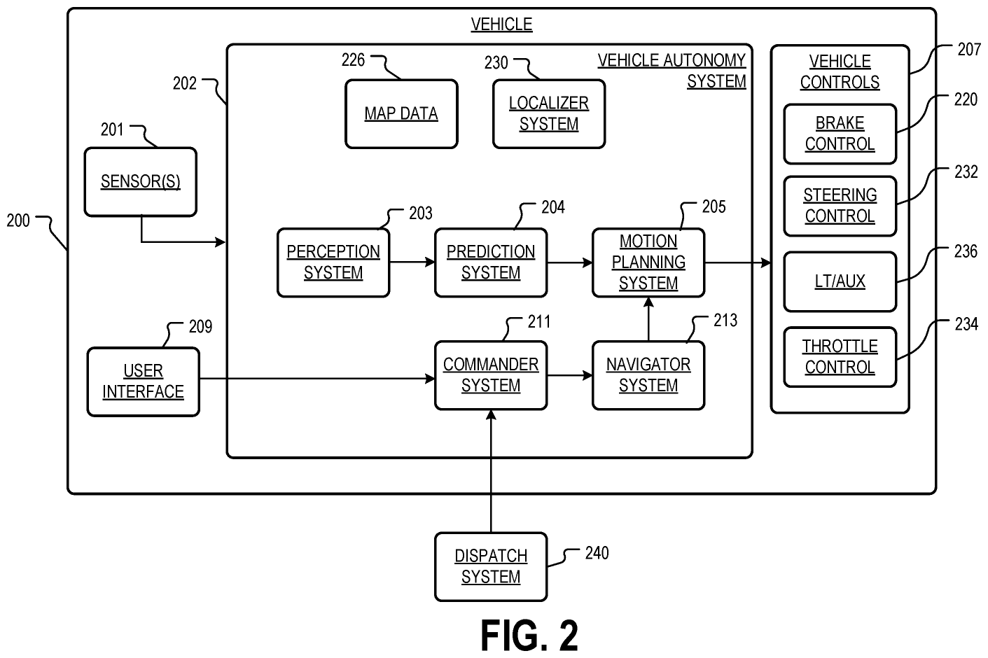

In some examples, the SDV 102 is operable in different modes, where the vehicle autonomy system 106 has differing levels of control over the SDV 102 in different modes. In some examples, the SDV 102 is operable in a fully autonomous mode in which the vehicle autonomy system 106 has responsibility for all or most of the controls of the SDV 102. In addition to or instead of the fully autonomous mode, the vehicle autonomy system 106, in some examples, is operable in a semi-autonomous mode in which a human user or driver is responsible for some control of the SDV 102. The SDV 102 may also be operable in a manual mode in which the human user is responsible for all control of the SDV 102. Additional details of an example vehicle autonomy system 106 are provided in FIG. 2.

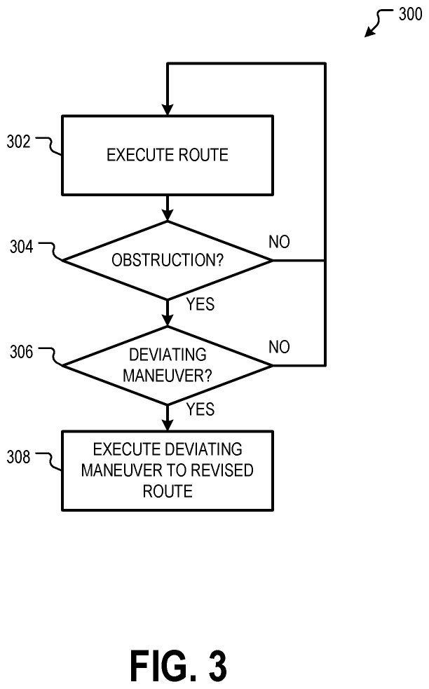

The SDV 102 has one or more remote-detection sensors 103 that receive return signals from the environment 100. Return signals may be reflected from objects in the environment 100, such as the ground, buildings, trees, etc. The remote-detection sensors 103 may include one or more active sensors, such as LIDAR, RADAR, and/or SONAR sensors, that emit sound or electromagnetic radiation in the form of light or radio waves to generate return signals. The remote-detection sensors 103 can also include one or more passive sensors, such as cameras or other imaging sensors, proximity sensors, and so forth, that receive return signals that originated from other sources of sound or electromagnetic radiation. Information about the environment 100 is extracted from the return signals. In some examples, the remote-detection sensors 103 include one or more passive sensors that receive reflected ambient light or other radiation, such as a set of monoscopic or stereoscopic cameras. The remote-detection sensors 103 provide remote-detection sensor data that describes the environment 100. The SDV 102 can also include other types of sensors, for example, as described in more detail with respect to FIG. 3.

In some examples, the SDV 102 also includes a routing engine 108. The routing engine 108 is programmed to generate routes for the SDV 102. The routing engine 108 may generate an initial route for the SDV 102 and/or may generate a revised route, for example, when the SDV 102 executes a deviating maneuver away from an obstruction as described herein.

In some examples, the routing engine 108 generates routes for the SDV using a routing graph. A routing graph is a graph that represents roadways as a set of graph elements. A graph element is a component of a routing graph that represents a roadway segment on which the SDV can travel. A graph element can be or include an edge, node, or other component of a routing graph. A graph element represents a portion of roadway, referred to herein as a roadway segment and sometimes also called a lane segment. A roadway segment may be or include a lane, a portion of a lane, an intersection, a cul-de-sac, or any other suitable portion of a roadway that can be traversed by a vehicle.

The routing graph includes data describing directionality and connectivity for the graph elements. The directionality of a graph element describes limitations (if any) on the direction in which a vehicle can traverse the roadway segment corresponding to the graph element. The connectivity of a given graph element describes other graph elements to which the SDV can be routed from the given graph element.

The routing graph can also include cost data describing costs associated with graph elements. The cost data indicates a cost to traverse a roadway segment corresponding to a graph element or to transition between roadway segments corresponding to connected graph elements. Cost can be based on various factors including, for example, estimated driving time, danger risk, and so forth. In some examples, higher cost generally corresponds to more negative characteristics of a graph element or transition (e.g., longer estimated driving time, higher risk of danger, etc.).

The routing engine 108 determines a best route, for example, by applying a path-planning algorithm to the routing graph. Any suitable path-planning algorithm can be used, such as, for example, A*, D*, Focused D*, D* Lite, GD*, or Dijkstra's algorithm. The best route includes a string of connected graph elements between a route start point and a route end point. A route start point is a graph element corresponding to the roadway segment where a vehicle will begin a route. A route end point is a graph element corresponding to the roadway segment where the vehicle will end a route. Some routes also traverse one or more waypoints, where a waypoint is a graph element between the route start point and the route end point corresponding to a roadway segment that the SDV is to traverse on a route. In some examples, waypoints are used on routes for executing a transportation service for more than one passenger or more than one item of cargo. For example, passengers and/or cargo may be picked up and/or dropped off at some or all of the waypoints. The best route identified by the path-planning algorithm may be the route with the lowest cost (e.g., the route that has the lowest cost or the highest benefit).

In some examples, instead of generating the initial route using the onboard routing engine 108, the SDV 102 receives a route from an external device, such as a dispatch system that assigns transportation services to the SDV 102. For example, a dispatch system may assign a transportation service to the SDV 102 instructing the SDV 102 to transport a payload (e.g., passengers or cargo) to the route end point. The dispatch system may provide an initial route that the SDV 102 is to take to fulfill the transportation service.

The vehicle autonomy system 106 is programmed to detect an obstruction along an initial route and consider whether to cause the SDV 102 to execute a deviating maneuver away from the initial route to a revised route. For example, the vehicle autonomy system 106 may detect that the SDV 102 is approaching an obstruction. In some examples, the obstructions detected by the vehicle autonomy system 106 are obstructions that were unknown to the routing engine 108 at the time that the route for the SDV 102 was generated. For example, obstructions detected by the vehicle autonomy system 106 may be of a temporary nature, such as a traffic signal indicating a stop instruction, a temporary construction, double-parked vehicle, and so forth. In some examples, an obstruction known to the routing engine 108 at the time that the route for the SDV was generated may be considered when generating the route and, therefore, may not need a deviating maneuver.

Upon determining that the SDV 102 is approaching an obstruction, the vehicle autonomy system 106 may determine whether a deviating maneuver is available. A deviating maneuver is available, for example, if there is a roadway where the SDV 102 can turn before being detained by the obstruction and if there is a viable revised route to the target after making the deviating maneuver. If a deviating maneuver is available, the vehicle autonomy system 106 determines whether to take the deviating maneuver or to continue on the initial route, for example, as described herein.

In the example of FIG. 1, the environment 100 also includes a roadway grid 110 including various example roadways. The roadway grid 110 illustrates an initial route 116 to be taken by the SDV 102. The initial route 116 extends from a route start point 112 to a route end point 114. The initial route 116 can be determined by the routing engine 108 and/or may be received from an external routing engine. The direction of travel on the initial route 116 is indicated by the indicated arrows. The initial route 116 consists of roadway segments.

The example roadway grid 110 shows obstructions 118, 120, and 122 on the initial route 116. As the SDV 102 approaches the obstructions 118, 120, and 122, the vehicle autonomy system 106 determines whether to execute a turn or continue on the initial route 116.

In the example of FIG. 1, the obstruction 118 is a traffic signal that indicates a stop instruction for vehicles along the direction of travel of the SDV 102 (e.g., travel along the initial route 116). For example, the traffic signal may indicate a red light. The vehicle autonomy system 106 determines that a turn to a revised route 124 is available. In this case, the vehicle autonomy system 106 determines that a turn to the roadways making up the revised route 124 is available prior to the traffic signal (or at the traffic signal), and that the revised route 124 has a viable path to the target (here, the route end point 114).

In some examples, the vehicle autonomy system 106 considers only deviating maneuvers that move the SDV 102 towards the target. As described herein, the target is either the next way point that the SDV 102 is to pass on a route or the route end point 114. In this example, no waypoints are shown in FIG. 1, so the target is the route end point 114. A maneuver towards a target is a maneuver that does not take the SDV 102 farther away from the target. In the example of FIG. 1, the target (e.g., route end point 114) is south and east of the obstruction 118. The maneuver to the revised route 124 is to the south and would not move the SDV 102 farther away from the target (e.g., route end point 114). Accordingly, the deviating maneuver to the revised route 124 is towards the target (e.g., route end point 114).

Upon determining that a deviating maneuver to the revised route 124 is available, the vehicle autonomy system 106 determines whether to take the deviating maneuver or to remain on the initial route 116. This decision can be made in any suitable manner. In some examples, the vehicle autonomy system 106 makes the determination based on the state of the traffic signal. For example, if the traffic signal indicates a stop instruction in the direction of the initial route 116 but indicates that traffic making the turn can go, then the vehicle autonomy system 106 may cause the SDV 102 to make the turn to the route 124.

In other examples, the vehicle autonomy system 106 considers estimated times-to-target if the SDV 102 continues on the initial route 116 and if the SDV 102 makes the turn. For example, the SDV 102 may request that the routing engine 108 generate a time-to-target if the SDV 102 were to make the turn to the revised route 124. The vehicle autonomy system 106 may also estimate a time that the SDV 102 will be delayed by the traffic signal. This time may be added to a time-to-target for the initial route 116 to generate an updated time-to-target for the initial route 116. If the updated time-to-target for the initial route is longer than the time-to-target for the revised route 124, then the SDV 102 makes the turn to the route 124. Otherwise, the vehicle autonomy system 106 causes the SDV 102 to remain on the initial route 116. In some examples, the time-to-target for the revised route 124 can be less than the updated time-to-target for the initial route 116 in view of the obstruction, even if the traffic signal for making the deviating maneuver to the revised route 124 indicates a stop instruction. For example, the traffic signal may be configured to provide a go instruction for the deviating maneuver before it provides a go instruction for continuing on the initial route 116.

A difference between the updated time-to-target for the initial route and the time-to-target for the revised route indicates a time gained or lost by continuing on the initial route. For example, if the updated time-to-target for the initial route is greater than the time-to-target for the revised route, the difference can be referred to as a time gained by taking the revised route or a time lost by remaining on the initial route. Similarly, if the updated time-to-target for the initial route is less than the time-to-target for the revised route, the difference can be referred to as a time gained by remaining on the initial route or a time lost by taking the deviating maneuver to the revised route.

The example of FIG. 1 also shows another obstruction 120. In this example, the obstruction is not at an intersection between roadways and is not a traffic signal. For example, the obstruction 120 may be stopped car, a closed lane, and so forth. The vehicle autonomy system 106 determines that a deviating maneuver to a revised route 126 is available. In this example, the deviating maneuver to the revised route 126 is towards the target. For example, the target (e.g., the route end point 114) is to the south and east of the obstruction 120. The revised route 126 turns the SDV east, which is not away from the target.

Another obstruction 122 is at an intersection between roadways and may be or include a traffic signal. The obstruction 122 illustrates an example where the deviating maneuver does not include a turn. As shown, executing a deviating maneuver to the alternative route 128 involves continuing straight while staying on the initial route 116 involves making a left turn, as shown.

FIG. 1 also shows a traffic signal system 130. The traffic signal system 130 stores traffic signal schedule data 132. The traffic signal schedule data 132 may indicate the current state of traffic signals on the roadway grid 110 and, in some examples, also includes data about when traffic signals on the roadway grid 110 will change. This can include, for example, the lengths of various periods of a traffic signal's cycle and/or scheduled times for changes in the state of a traffic signal. The SDV 102 may receive the traffic signal schedule data 132 and utilize the traffic signal schedule data 132 to detect obstructions 118.

The traffic signal system 130 may generate the traffic signal schedule data 132 in any suitable manner. In some examples, traffic signal schedule data 130 is generated by or for a traffic signal control system that controls a set of one or more traffic signals. The traffic signal system 130 may access the traffic signal schedule data from the traffic signal control system or other suitable associated system. In another example, the traffic signal system 130 generates traffic signal schedule data 132 from reports generated by other vehicles, including SDVs or human-driven vehicles. For example, other vehicles may report the states of a set of one or more traffic signals when the respective vehicles encounter the traffic signals. From the reports, the traffic signal system 130 may generate the traffic signal schedule data 132.

The vehicle autonomy system 106 may utilize traffic signal schedule data 132 to predict whether the SDV 102 will arrive at an intersection when the traffic signal indicates a stop instruction (for example, before the remote-detection sensors 103 of the SDV 102 are able to discern the state of the traffic signal). For example, the vehicle autonomy system 106 may predict a time when the SDV 102 will reach a traffic signal. Using the traffic signal schedule data 132, the vehicle autonomy system 106 may also predict a state of the traffic signal at the time that the SDV 102 will reach the traffic signal. If the predicted state of the traffic signal indicates a stop instruction, the vehicle autonomy system 106 detects an obstruction.

FIG. 2 depicts a block diagram of an example vehicle 200, according to example aspects of the present disclosure. The vehicle 200 includes one or more sensors 201, a vehicle autonomy system 202, and one or more vehicle controls 207. The vehicle 200 is an SDV, as described herein.

The vehicle autonomy system 202 includes a commander system 211, a navigator system 213, a perception system 203, a prediction system 204, a motion planning system 205, and a localizer system 230 that cooperate to perceive the surrounding environment of the vehicle 200 and determine a motion plan for controlling the motion of the vehicle 200 accordingly.

The vehicle autonomy system 202 is engaged to control the vehicle 200 or to assist in controlling the vehicle 200. In particular, the vehicle autonomy system 202 receives sensor data from the one or more sensors 201, attempts to comprehend the environment surrounding the vehicle 200 by performing various processing techniques on data collected by the sensors 201, and generates an appropriate route through the environment. The vehicle autonomy system 202 sends commands to control the one or more vehicle controls 207 to operate the vehicle 200 according to the route.

Various portions of the vehicle autonomy system 202 receive sensor data from the one or more sensors 201. For example, the sensors 201 may include remote-detection sensors as well as motion sensors such as an inertial measurement unit (IMU), one or more encoders, or one or more odometers. The sensor data includes information that describes the location of objects within the surrounding environment of the vehicle 200, information that describes the motion of the vehicle 200, and so forth.

The sensors 201 may also include one or more remote-detection sensors or sensor systems, such as a LIDAR system, a RADAR system, one or more cameras, and the like. As one example, a LIDAR system of the one or more sensors 201 generates sensor data (e.g., remote-detection sensor data) that includes the location (e.g., in three-dimensional space relative to the LIDAR system) of a number of points that correspond to objects that have reflected a ranging laser. For example, the LIDAR system measures distances by measuring the Time of Flight (TOF) that it takes a short laser pulse to travel from the sensor to an object and back, calculating the distance from the known speed of light.

As another example, a RADAR system of the one or more sensors 201 generates sensor data (e.g., remote-detection sensor data) that includes the location (e.g., in three-dimensional space relative to the RADAR system) of a number of points that correspond to objects that have reflected ranging radio waves. For example, radio waves (e.g., pulsed or continuous) transmitted by the RADAR system reflect off an object and return to a receiver of the RADAR system, giving information about the object's location and speed. Thus, a RADAR system provides useful information about the current speed of an object.

As yet another example, one or more cameras of the one or more sensors 201 may generate sensor data (e.g., remote-detection sensor data) including still or moving images. Various processing techniques (e.g., range imaging techniques such as, for example, structure from motion, structured light, stereo triangulation, and/or other techniques) can be performed to identify the location (e.g., in three-dimensional space relative to the one or more cameras) of a number of points that correspond to objects that are depicted in an image or images captured by the one or more cameras. Other sensor systems can identify the location of points that correspond to objects as well.

As another example, the one or more sensors 201 can include a positioning system. The positioning system determines a current position of the vehicle 200. The positioning system can be any device or circuitry for analyzing the position of the vehicle 200. For example, the positioning system can determine a position by using one or more of inertial sensors, a satellite positioning system such as the Global Positioning System (GPS), a positioning system based on Internet Protocol (IP) address, triangulation and/or proximity to network access points or other network components (e.g., cellular towers, Wi-Fi access points), and/or other suitable techniques. The position of the vehicle 200 can be used by various systems of the vehicle autonomy system 202.

Thus, the one or more sensors 201 are used to collect sensor data that includes information that describes the location (e.g., in three-dimensional space relative to the vehicle 200) of points that correspond to objects within the surrounding environment of the vehicle 200. In some implementations, the sensors 201 can be positioned at various different locations on the vehicle 200. As an example, in some implementations, one or more cameras and/or LIDAR sensors can be located in a pod or other structure that is mounted on a roof of the vehicle 200, while one or more RADAR sensors can be located in or behind the front and/or rear bumper(s) or body panel(s) of the vehicle 200. As another example, one or more cameras can be located at the front or rear bumper(s) of the vehicle 200. Other locations can be used as well.

The localizer system 230 receives some or all of the sensor data from the sensors 201 and generates vehicle poses for the vehicle 200. A vehicle pose describes a position and attitude of the vehicle 200. The vehicle pose (or portions thereof) can be used by various other components of the vehicle autonomy system 202 including, for example, the perception system 203, the prediction system 204, the motion planning system 205, and the navigator system 213.

The position of the vehicle 200 is a point in a three-dimensional space. In some examples, the position is described by values for a set of Cartesian coordinates, although any other suitable coordinate system may be used. The attitude of the vehicle 200 generally describes the way in which the vehicle 200 is oriented at its position. In some examples, attitude is described by a yaw about the vertical axis, a pitch about a first horizontal axis, and a roll about a second horizontal axis. In some examples, the localizer system 230 generates vehicle poses periodically (e.g., every second, every half second). The localizer system 230 appends time stamps to vehicle poses, where the time stamp for a pose indicates the point in time that is described by the pose. The localizer system 230 generates vehicle poses by comparing sensor data (e.g., remote-detection sensor data) to map data 226 describing the surrounding environment of the vehicle 200.

In some examples, the localizer system 230 includes one or more pose estimators and a pose filter. Pose estimators generate pose estimates by comparing remote-detection sensor data (e.g., LIDAR, RADAR) to map data. The pose filter receives pose estimates from the one or more pose estimators as well as other sensor data such as, for example, motion sensor data from an IMU, encoder, or odometer. In some examples, the pose filter executes a Kalman filter or machine learning algorithm to combine pose estimates from the one or more pose estimators with motion sensor data to generate vehicle poses. In some examples, pose estimators generate pose estimates at a frequency less than the frequency at which the localizer system 230 generates vehicle poses. Accordingly, the pose filter generates some vehicle poses by extrapolating from a previous pose estimate utilizing motion sensor data.

Vehicle poses and/or vehicle positions generated by the localizer system 230 are provided to various other components of the vehicle autonomy system 202. For example, the commander system 211 may utilize a vehicle position to determine whether to respond to a call from a dispatch system 240.

The commander system 211 determines a set of one or more target locations that are used for routing the vehicle 200. The target locations are determined based on user input received via a user interface 209 of the vehicle 200. The user interface 209 may include and/or use any suitable input/output device or devices. In some examples, the commander system 211 determines the one or more target locations considering data received from the dispatch system 240. The dispatch system 240 is programmed to provide instructions to multiple vehicles (for example, as part of a fleet of vehicles for moving passengers and/or cargo). Data from the dispatch system 240 can be provided via a wireless network, for example.

The navigator system 213 receives one or more target locations from the commander system 211 and map data 226. The map data 226, for example, provides detailed information about the surrounding environment of the vehicle 200. The map data 226 provides information regarding identity and location of different roadways and segments of roadways (e.g., lane segments or graph elements). A roadway is a place where the vehicle 200 can drive and may include, for example, a road, a street, a highway, a lane, a parking lot, or a driveway. Routing graph data is a type of map data 226.

From the one or more target locations and the map data 226, the navigator system 213 generates route data describing a route for the vehicle 200 to take to arrive at the one or more target locations. In some implementations, the navigator system 213 determines route data using one or more path-planning algorithms based on costs for graph elements, as described herein. For example, a cost for a route can indicate a time of travel, risk of danger, or other factor associated with adhering to a particular candidate route. Route data describing a route is provided to the motion planning system 205, which commands the vehicle controls 207 to implement the route or route extension, as described herein. The navigator system 213 can generate routes as described herein using a general-purpose routing graph and routing graph modification data. Also, in examples where route data is received from the dispatch system 240, that route data can also be provided to the motion planning system 205.

The perception system 203 detects objects in the surrounding environment of the vehicle 200 based on sensor 201 data, the map data 226, and/or vehicle poses provided by the localizer system 230. For example, the map data 226 used by the perception system 203 describes roadways and segments thereof and may also describe buildings or other items or objects (e.g., lampposts, crosswalks, curbing); location and directions of traffic lanes or lane segments (e.g., the location and direction of a parking lane, a turning lane, a bicycle lane, or other lanes within a particular roadway); traffic control data (e.g., the location and instructions of signage, traffic signals, or other traffic control devices); and/or any other map data that provides information that assists the vehicle autonomy system 202 in comprehending and perceiving its surrounding environment and its relationship thereto.

In some examples, the perception system 203 determines state data for one or more of the objects in the surrounding environment of the vehicle 200. State data describes a current state of an object (also referred to as features of the object). The state data for each object describes, for example, an estimate of the object's current location (also referred to as position); current speed (also referred to as velocity); current acceleration; current heading; current orientation; size/shape/footprint (e.g., as represented by a bounding shape such as a bounding polygon or polyhedron); type/class (e.g., vehicle, pedestrian, bicycle, or other); yaw rate; distance from the vehicle 200; minimum path to interaction with the vehicle 200; minimum time duration to interaction with the vehicle 200; and/or other state information.

In some implementations, the perception system 203 determines state data for each object over a number of iterations. In particular, the perception system 203 updates the state data for each object at each iteration. Thus, the perception system 203 detects and tracks objects, such as other vehicles, that are proximate to the vehicle 200 over time.

The prediction system 204 is configured to predict one or more future positions for an object or objects in the environment surrounding the vehicle 200 (e.g., an object or objects detected by the perception system 203). The prediction system 204 generates prediction data associated with one or more of the objects detected by the perception system 203. In some examples, the prediction system 204 generates prediction data describing each of the respective objects detected by the perception system 203.

Prediction data for an object is indicative of one or more predicted future locations of the object. For example, the prediction system 204 may predict where the object will be located within the next 5 seconds, 20 seconds, 200 seconds, and so forth. Prediction data for an object may indicate a predicted trajectory (e.g., predicted path) for the object within the surrounding environment of the vehicle 200. For example, the predicted trajectory (e.g., path) can indicate a path along which the respective object is predicted to travel over time (and/or the speed at which the object is predicted to travel along the predicted path). The prediction system 204 generates prediction data for an object, for example, based on state data generated by the perception system 203. In some examples, the prediction system 204 also considers one or more vehicle poses generated by the localizer system 230 and/or map data 226.

In some examples, the prediction system 204 uses state data indicative of an object type or classification to predict a trajectory for the object. As an example, the prediction system 204 can use state data provided by the perception system 203 to determine that a particular object (e.g., an object classified as a vehicle) approaching an intersection and maneuvering into a left-turn lane intends to turn left. In such a situation, the prediction system 204 predicts a trajectory (e.g., path) corresponding to a left-turn for the vehicle such that the vehicle turns left at the intersection. Similarly, the prediction system 204 determines predicted trajectories for other objects, such as bicycles, pedestrians, parked vehicles, and so forth. The prediction system 204 provides the predicted trajectories associated with the object(s) to the motion planning system 205.

In some implementations, the prediction system 204 is a goal-oriented prediction system 204 that generates one or more potential goals, selects one or more of the most likely potential goals, and develops one or more trajectories by which the object can achieve the one or more selected goals. For example, the prediction system 204 can include a scenario generation system that generates and/or scores the one or more goals for an object, and a scenario development system that determines the one or more trajectories by which the object can achieve the goals. In some implementations, the prediction system 204 can include a machine-learned goal-scoring model, a machine-learned trajectory development model, and/or other machine-learned models.

The motion planning system 205 commands the vehicle controls 207 based at least in part on the predicted trajectories associated with the objects within the surrounding environment of the vehicle 200, the state data for the objects provided by the perception system 203, vehicle poses provided by the localizer system 230, the map data 226, and route or route extension data provided by the navigator system 213. Stated differently, given information about the current locations of objects and/or predicted trajectories of objects within the surrounding environment of the vehicle 200, the motion planning system 205 determines control commands for the vehicle 200 that best navigate the vehicle 200 along the route or route extension relative to the objects at such locations and their predicted trajectories on acceptable roadways.

In some implementations, the motion planning system 205 can also evaluate one or more cost functions and/or one or more reward functions for each of one or more candidate control commands or sets of control commands for the vehicle 200. Thus, given information about the current locations and/or predicted future locations/trajectories of objects, the motion planning system 205 can determine a total cost (e.g., a sum of the cost(s) and/or reward(s) provided by the cost function(s) and/or reward function(s)) of adhering to a particular candidate control command or set of control commands. The motion planning system 205 can select or determine a control command or set of control commands for the vehicle 200 based at least in part on the cost function(s) and the reward function(s). For example, the motion plan that minimizes the total cost can be selected or otherwise determined.

In some implementations, the motion planning system 205 can be configured to iteratively update the route or route extension for the vehicle 200 as new sensor data is obtained from the one or more sensors 201. For example, as new sensor data is obtained from the one or more sensors 201, the sensor data can be analyzed by the perception system 203, the prediction system 204, and the motion planning system 205 to determine the motion plan.

The motion planning system 205 can provide control commands to the one or more vehicle controls 207. For example, the one or more vehicle controls 207 can include throttle systems, brake systems, steering systems, and other control systems, each of which can include various vehicle controls (e.g., actuators or other devices that control gas flow, steering, and braking) to control the motion of the vehicle 200. The various vehicle controls 207 can include one or more controllers, control devices, motors, and/or processors.

The vehicle controls 207 can include a brake control module 220. The brake control module 220 is configured to receive a braking command and bring about a response by applying (or not applying) the vehicle brakes. In some examples, the brake control module 220 includes a primary system and a secondary system. The primary system receives braking commands and, in response, brakes the vehicle 200. The secondary system may be configured to determine a failure of the primary system to brake the vehicle 200 in response to receiving the braking command.

A steering control system 232 is configured to receive a steering command and bring about a response in the steering mechanism of the vehicle 200. The steering command is provided to a steering system to provide a steering input to steer the vehicle 200.

A lighting/auxiliary control module 236 receives a lighting or auxiliary command. In response, the lighting/auxiliary control module 236 controls a lighting and/or auxiliary system of the vehicle 200. Controlling a lighting system may include, for example, turning on, turning off, or otherwise modulating headlights, parking lights, running lights, and the like. Controlling an auxiliary system may include, for example, modulating windshield wipers, a defroster, and the like.

A throttle control system 234 is configured to receive a throttle command and bring about a response in the engine speed or other throttle mechanism of the vehicle. For example, the throttle control system 234 can instruct an engine and/or engine controller, or other propulsion system component, to control the engine or other propulsion system of the vehicle 200 to accelerate, decelerate, or remain at its current speed.

Each of the perception system 203, the prediction system 204, the motion planning system 205, the commander system 211, the navigator system 213, and the localizer system 230 can be included in or otherwise be a part of the vehicle autonomy system 202 configured to control the vehicle 200 based at least in part on data obtained from the one or more sensors 201. For example, data obtained by the one or more sensors 201 can be analyzed by each of the perception system 203, the prediction system 204, and the motion planning system 205 in a consecutive fashion in order to control the vehicle 200. While FIG. 2 depicts elements suitable for use in a vehicle autonomy system according to example aspects of the present disclosure, one of ordinary skill in the art will recognize that other vehicle autonomy systems can be configured to control an SDV based on sensor data.

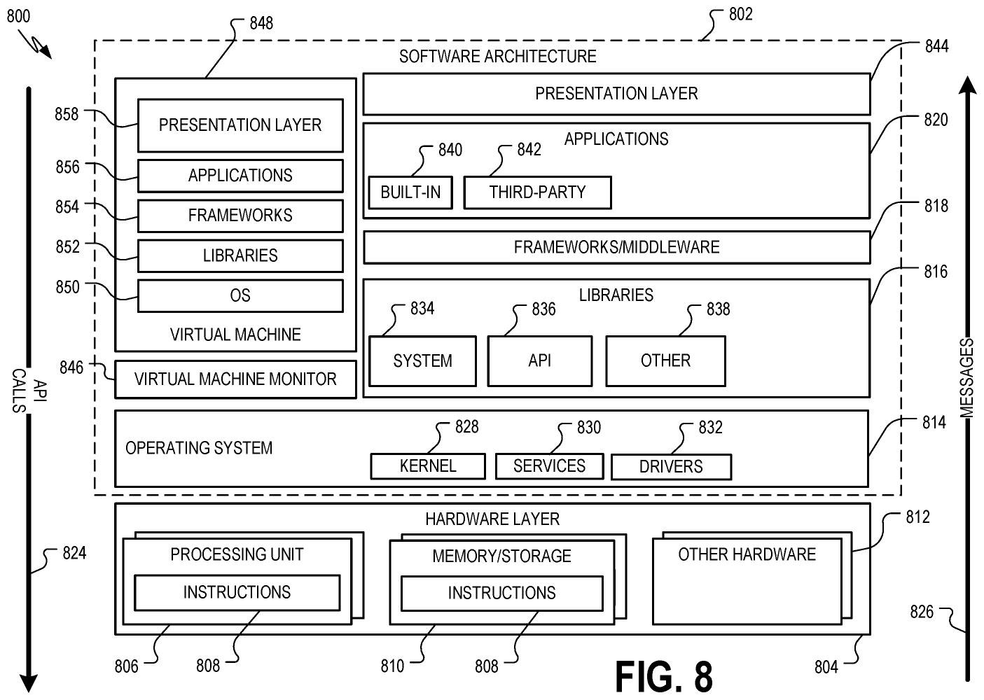

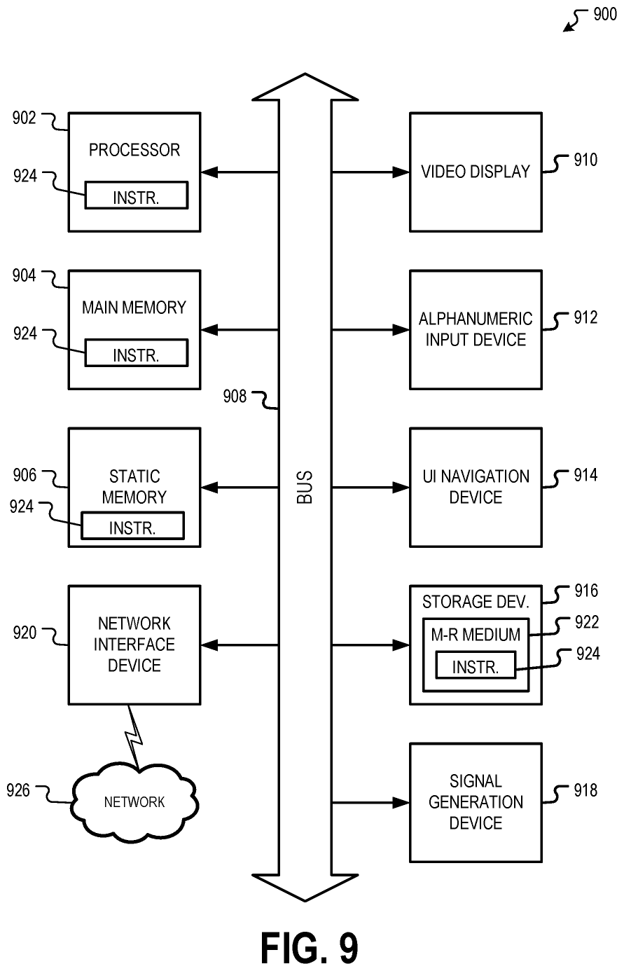

The vehicle autonomy system 202 includes one or more computing devices, which may implement all or parts of the perception system 203, the prediction system 204, the motion planning system 205, and/or the localizer system 230. Descriptions of hardware and software configurations for computing devices to implement the vehicle autonomy system 202 and/or the dispatch system 240 are provided herein with reference to FIGS. 8 and 9.

FIG. 3 is a flowchart showing one example of a process flow 300 that may be executed by the vehicle autonomy system 106 to detect and respond to an obstruction on an initial route. At operation 302, the vehicle autonomy system 106 executes a route. Executing a route can include providing instructions to the vehicle controls of an SDV so as to cause the SDV to traverse the route. As described herein, the route may include a sequence of roadway segments. The executed route may be an initial route determined by the routing engine 108 or another suitable system. In some examples, the executed route has been previously modified, for example, by a previous deviating maneuver as described herein.

At operation 304, the vehicle autonomy system 106 determines if the SDV is approaching an obstruction, such as described herein. If no obstruction is detected, the vehicle autonomy system 106 continues executing the route at operation 302. If an obstruction is detected, the vehicle autonomy system 106, at operation 306, determines whether to take a deviating maneuver around the obstruction. For example, as described herein, the vehicle autonomy system 106 may determine to take a deviating maneuver if there is an available deviating maneuver if a revised route including the deviating maneuver has a time-to-target lower than a time-to-target including the obstruction. In some examples, the vehicle autonomy system considers a total cost of a revised route including the deviating maneuver in addition to or instead of simply the time-to-target. For example, the total cost can consider business policy or other limitations on the SDV using the vehicle autonomy system 106. For example, a revised route including the deviating maneuver traversing a roadway segment that is disfavored for a business policy or other reason may add to the cost of the revised route.

If the vehicle autonomy system 106 determines not to take a deviating maneuver at operation 306, it may continue to execute the route at operation 302. If the vehicle autonomy system 106 determines to take the deviating maneuver at operation 306, it executes the deviating maneuver and continues to execute a revised route (including the deviating maneuver) at operation 308.

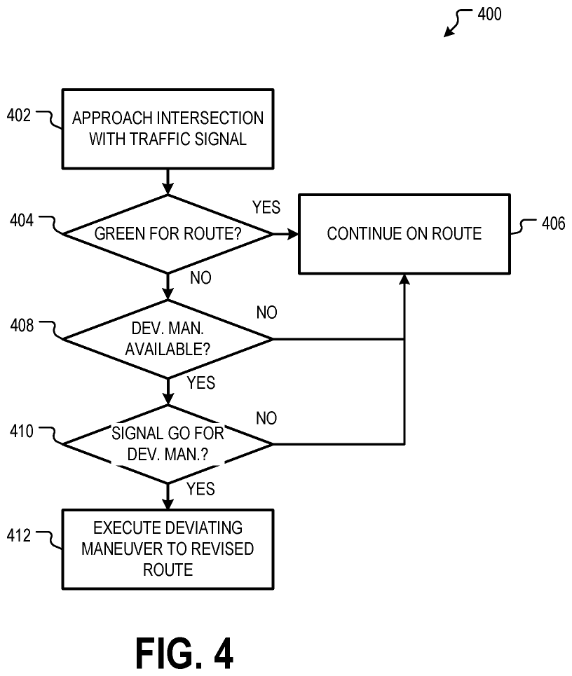

FIG. 4 is a flowchart showing one example of a process flow 400 that may be executed by the vehicle autonomy system 106 when approaching an intersection between two roadways where a traffic signal could generate an obstruction. In this example, the traffic signal is green for a route if it indicates a go instruction to vehicles on the direction of travel of the route.

At operation 402, the vehicle autonomy system 106 (e.g., the corresponding SDV) approaches an intersection with a traffic signal. (The intersection with the traffic signal is also referred to herein as the controlled intersection.) At operation 404, the vehicle autonomy system 106 determines if the traffic signal is green for the route being executed by the vehicle autonomy system. For example, if the route calls for the SDV to traverse straight though the intersection, then the traffic signal is green for the route if its state permits vehicles traveling straight to proceed through the controlled intersection. In another example, if the route being executed calls for the SDV to turn at the intersection, the traffic signal may be green for the route if it shows a green arrow or other indication that the SDV is permitted to make the turn called for by the route at the controlled intersection. If the traffic signal is green for the route, then the vehicle autonomy system 106 causes the SDV to continue on the route at operation 406.

If the traffic signal is not green for the route, then the vehicle autonomy system 106 determines at operation 408 whether there is a deviating maneuver available. For example, the vehicle autonomy system 106 and/or a routing engine 108 may determine whether there is a maneuver through the controlled intersection that the traffic signal will allow the SDV to traverse. If such a maneuver exists, the vehicle autonomy system and/or routing engine 108 determines if the maneuver can be part of a revised route having a time-to-target that is lower than the time-to-target of the current route, considering an expected wait at the traffic signal.

The wait at the traffic signal indicates the time that the SDV associated with the vehicle autonomy system 106 is likely to be stationary at the traffic signal before the traffic signal indicates a go direction for the initial route and/or for the deviating maneuver. The vehicle autonomy system 106 may estimate the wait at the traffic signal for the initial route and/or the revised route including the deviating maneuver in any suitable manner. For example, the vehicle autonomy system 106 may be programmed with data describing a cycle length of the traffic signal. The vehicle autonomy system 106 may estimate a current position in the traffic signal cycle in any suitable manner including, for example, by sensing outputs of the traffic signals (e.g., the state of walk signals, the state of the traffic signal for cross traffic, etc.). In some examples, the vehicle autonomy system 106 estimates the current position of the traffic signal cycle based on a number of cars stationary at the traffic signal. For example, a larger number of vehicles waiting to traverse the controlled intersection in a particular way may indicate that the cycle of the traffic signal is close to a position where the traffic signal will indicate a go instruction in that direction.

In some examples, the vehicle autonomy system 106 also considers the number of vehicles waiting at the traffic signal in the direction of either the initial route or in the direction of a deviating maneuver. For example, if more than a threshold number of vehicles are waiting to go straight at a red light, it may be an indication that the SDV including the vehicle autonomy system 106 is likely to wait through two or more cycles of the traffic signal before being able to traverse the controlled intersection. In another example, if more than a threshold number of vehicles is waiting to turn left at a green arrow of the traffic signal, it may indicate that the SDV including the vehicle autonomy system 106 will not be able to complete a left turn at the traffic signal for two or more cycles. The number of cycles that the SDV is likely to wait before traversing the intersection and/or before making a deviating maneuver may be considered when determining the time-to-target of waiting for the traffic signal to change and/or for making a deviating maneuver.

If no deviating maneuver is available or if an available maneuver does not result in a revised route that has a time-to-target that is less than the current route, then the vehicle autonomy system 106 causes the SDV to continue executing the route at operation 406. If a deviating maneuver is available at operation 408, then the vehicle autonomy system 106 determines, at operation 410, whether the traffic signal indicates go for the deviating maneuver. If the traffic signal does not indicate go for the deviating maneuver, the vehicle autonomy system 106 continues executing the route at operation 406. If the traffic signal does indicate go for the deviating maneuver, the vehicle autonomy system 106 executes the deviating maneuver and its associated revised route at operation 412.

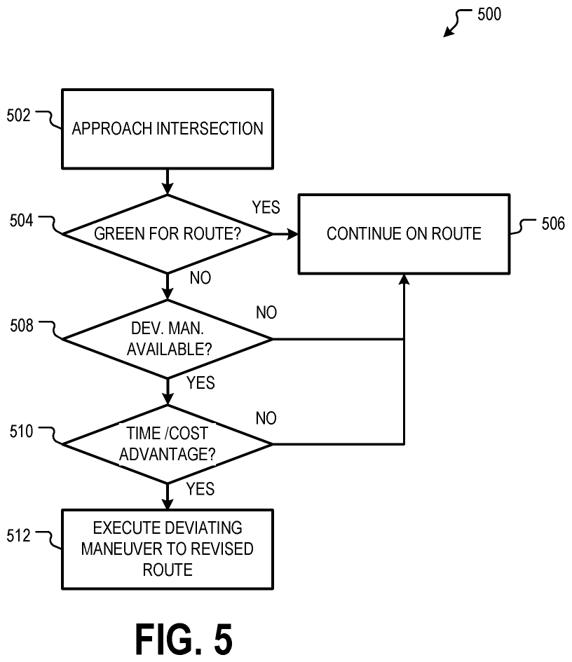

FIG. 5 is a flowchart showing one example of another process flow that may be executed by the vehicle autonomy system when approaching an intersection between two roadways where a traffic signal could generate an obstruction.

At operation 502, the vehicle autonomy system 106 (e.g., the corresponding SDV) approaches an intersection with a traffic signal. (The intersection with the traffic signal is also referred to herein as the controlled intersection.) At operation 504, the vehicle autonomy system 106 determines if the traffic signal is green for the route being executed by the vehicle autonomy system. For example, if the route calls for the SDV to traverse straight through the intersection, then the traffic signal is green for the route if its state permits vehicles traveling straight to proceed through the controlled intersection. In another example, if the route being executed calls for the SDV to turn at the intersection, the traffic signal may be green for the route if it shows a green arrow or other indication that the SDV is permitted to make the turn called for by the route at the controlled intersection. If the traffic signal is green for the route, then the vehicle autonomy system 106 causes the SDV to continue on the route at operation 506.

If the traffic signal is not green (e.g., does not indicate go) for the route, then the vehicle autonomy system 106 determines at operation 508 whether there is a deviating maneuver available. For example, the vehicle autonomy system 106 and/or a routing engine 108 may determine whether there is a maneuver through the controlled intersection that the traffic signal will allow the SDV to traverse. If no such maneuver is found, the vehicle autonomy system 106 continues executing the route at operation 506. If such a maneuver exists, the vehicle autonomy system and/or routing engine 108 determines, at operation 510, if the maneuver can be part of a revised route having a time-to-target and/or cost that is lower than the cost of the current route (considering an expected wait at the traffic signal). If no such maneuver is available or if an available maneuver does not result in a revised route that has a time-to-target and/or cost lower than the current route, then the vehicle autonomy system 106 causes the SDV to continue executing the route at operation 506. If a deviating maneuver is available at operation 508, then the vehicle autonomy system executes the deviating maneuver and its associated revised route at operation 512.

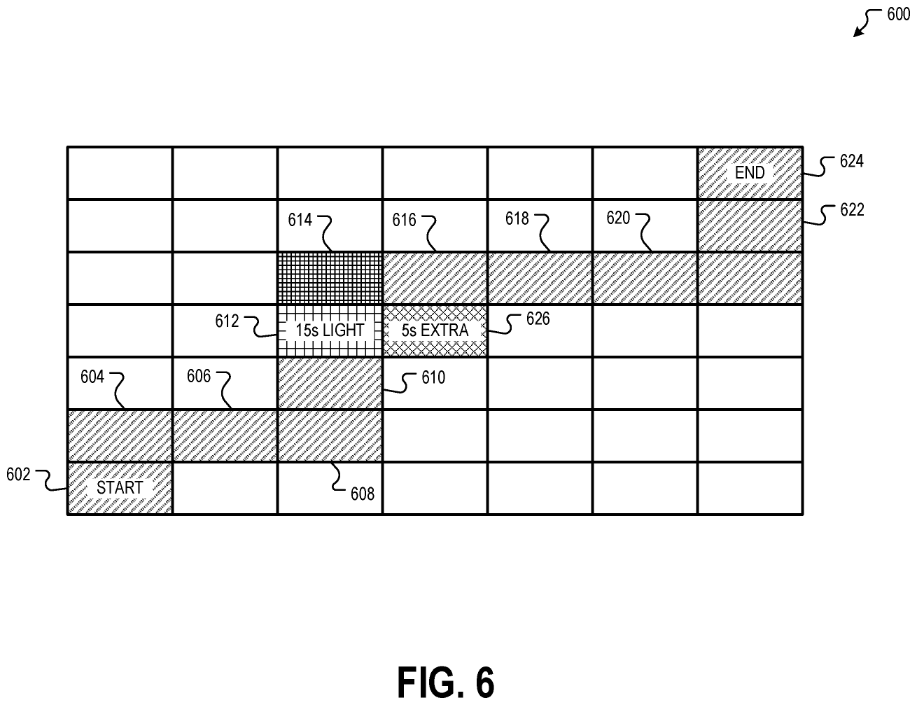

FIG. 6 is a diagram 600 that illustrates an example deviating maneuver executed by an SDV, such as the SDV 102. The diagram 600 represents roadway segments as blocks. An initial route would have begin at a route start point roadway segment 602 and proceeded to roadway segments 604, 606, 608, 610, 612, 614, 616, 618, 620, 622 and finally to a route end roadway segment 624. In this example, the route end roadway segment 624 is the target.

In the example of FIG. 6, the SDV proceeds along the initial route. The vehicle autonomy system detects an obstruction at roadway segment 612. In this example, the vehicle autonomy system determines that proceeding through the obstruction would add fifteen (15) seconds to the time-to-target. The vehicle autonomy system, however, also identifies a deviating maneuver that would have the SDV proceed to roadway segment 626 and then to roadway segment 616. The vehicle autonomy system determines that this deviating maneuver would add five (5) seconds to the time-to-target. Because the addition to the time-to-target is greater for remaining on the initial target than it is for making the deviating maneuver to roadway segment 626, the vehicle autonomy system causes the SDV to make the deviating maneuver to the roadway segment 626.

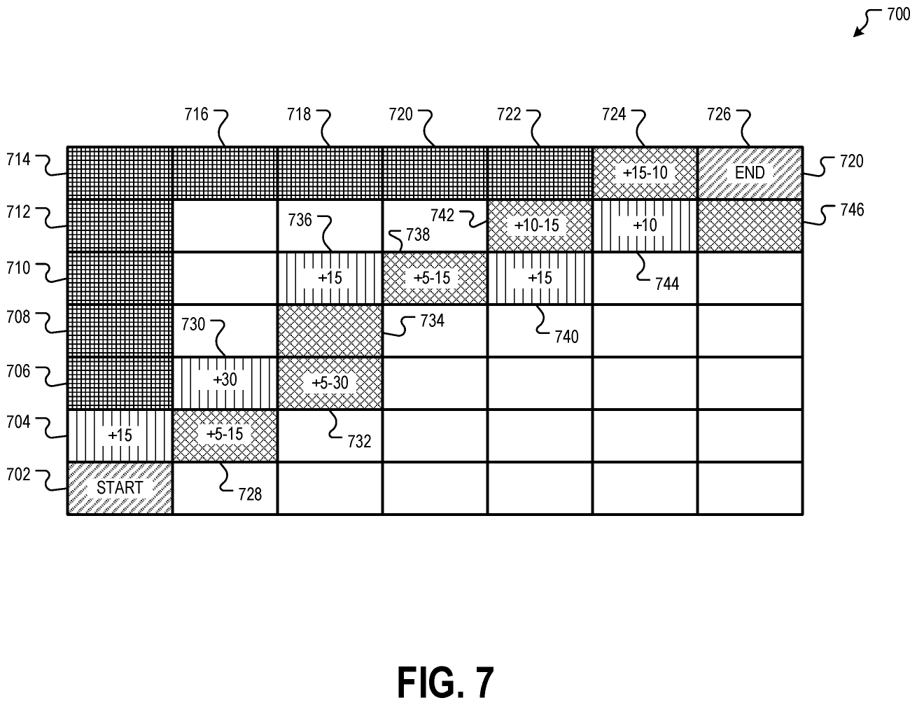

FIG. 7 is a diagram 700 that illustrates other example deviating maneuvers executed by an SDV, such as the SDV 102. The diagram 700 also represents roadway segments as blocks. An initial route would begin at a route start point roadway segment 702 and proceed to a route end point roadway segment 726 via roadway segments 704, 706, 708, 710, 712, 714, 716, 718, 720, 722, and 724. In this example, the target is the end point roadway segment 726.

In the example of FIG. 7, the vehicle autonomy system detects an obstruction at roadway segment 704 (e.g., the light is red). In this example, proceeding on the initial route would add fifteen (15) seconds to the time-to-target. A deviating maneuver to roadway segment 728 would add five (5) seconds to the time-to-target. Accordingly, the deviating maneuver would add five seconds and subtract fifteen (15), for a net reduction in the time-to-target of ten (10) seconds. Accordingly, the vehicle autonomy system causes the SDV to make the deviating maneuver to the roadway segment 728.

An additional obstruction (e.g., red light) is detected at roadway segment 730. Waiting at the obstruction would add thirty (30) seconds to the time-to-target. Here, a deviating maneuver to the roadway segment 732 would add five (5) seconds to the time-to-target, for a net reduction in the time-to-target of twenty-five (25) seconds. Accordingly, the vehicle autonomy system causes the SDV to make the deviating maneuver to the roadway segment 732.

The SDV proceeds to roadway segment 734. An additional obstruction is detected at roadway segment 736. In this example, waiting to traverse the obstruction would add fifteen (15) seconds to the time-to-target. A deviating maneuver to roadway segment 738 is available with an addition of five (5) seconds to the time-to-target. The result of taking the deviating maneuver is a net reduction of ten (10) seconds, so the vehicle autonomy system causes the SDV to make the deviating maneuver to the roadway segment 738.

An additional obstruction is detected at roadway segment 740. This obstruction adds fifteen (15) seconds to the time-to-target. A deviating maneuver to roadway segment 742 is a left turn and adds ten (10) seconds to the time-to-target. The change to the time-to-target for taking the deviating maneuver to the roadway segment 742 is still a net reduction of five (5) seconds, so the vehicle autonomy system causes the SDV to take the deviating maneuver.

Another obstruction is detected at roadway segment 744. This obstruction adds ten (10) seconds to the time-to-target. A deviating maneuver to roadway segment 724 is available, but it adds fifteen (15) seconds to the time-to-target. Accordingly, the vehicle autonomy system declines to execute the deviating maneuver and proceeds to roadway segment 746 and ultimately to the target, which in this example is roadway segment 726 which, in this example, is the route end point.

FIG. 8 is a block diagram 800 showing one example of a software architecture 802 for a computing device. The software architecture 802 may be used in conjunction with various hardware architectures, for example, as described herein. FIG. 8 is merely a non-limiting example of a software architecture 802, and many other architectures may be implemented to facilitate the functionality described herein. A representative hardware layer 804 is illustrated and can represent, for example, any of the above-referenced computing devices. In some examples, the hardware layer 804 may be implemented according to an architecture 900 of FIG. 9 and/or the software architecture 802 of FIG. 8.

The representative hardware layer 804 comprises one or more processing units 806 having associated executable instructions 808. The executable instructions 808 represent the executable instructions of the software architecture 802, including implementation of the methods, modules, components, and so forth of FIGS. 1-9. The hardware layer 804 also includes memory and/or storage modules 810, which also have the executable instructions 808. The hardware layer 804 may also comprise other hardware 812, which represents any other hardware of the hardware layer 804, such as the other hardware illustrated as part of the architecture 900.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and a presentation layer 844. Operationally, the applications 820 and/or other components within the layers may invoke application programming interface (API) calls 824 through the software stack and receive a response, returned values, and so forth illustrated as messages 826 in response to the API calls 824. The layers illustrated are representative in nature, and not all software architectures have all layers. For example, some mobile or special-purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of a hardware or software interrupt and, in response, cause the software architecture 802 to pause its current processing and execute an interrupt service routine (ISR) when an interrupt is received. The ISR may generate an alert.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), WiFi® drivers, near-field communication (NFC) drivers, audio drivers, power management drivers, and so forth depending on the hardware configuration.

The libraries 816 may provide a common infrastructure that may be used by the applications 820 and/or other components and/or layers. The libraries 816 typically provide functionality that allows other software modules to perform tasks in an easier fashion than by interfacing directly with the underlying operating system 814 functionality (e.g., kernel 828, services 830, and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be used by the applications 820 and/or other software components/modules. For example, the frameworks 818 may provide various graphical user interface (GUI) functions, high-level resource management, high-level location services, and so forth. The frameworks 818 may provide a broad spectrum of other APIs that may be used by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. The third-party applications 842 may include any of the built-in applications 840 as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 842 may invoke the API calls 824 provided by the mobile operating system such as the operating system 814 to facilitate functionality described herein.

The applications 820 may use built-in operating system functions (e.g., kernel 828, services 830, and/or drivers 832), libraries (e.g., system libraries 834, API libraries 836, and other libraries 838), or frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with a user.

Some software architectures use virtual machines. For example, systems described herein may be executed using one or more virtual machines executed at one or more server computing machines. In the example of FIG. 8, this is illustrated by a virtual machine 848. A virtual machine creates a software environment where applications/modules can execute as if they were executing on a hardware computing device. The virtual machine 848 is hosted by a host operating system (e.g., the operating system 814) and typically, although not always, has a virtual machine monitor 846, which manages the operation of the virtual machine 848 as well as the interface with the host operating system (e.g., the operating system 814). A software architecture executes within the virtual machine 848, such as an operating system 850, libraries 852, frameworks/middleware 854, applications 856, and/or a presentation layer 858. These layers of software architecture executing within the virtual machine 848 can be the same as corresponding layers previously described or may be different.

FIG. 9 is a block diagram illustrating a computing device hardware architecture 900, within which a set or sequence of instructions can be executed to cause a machine to perform examples of any one of the methodologies discussed herein. The hardware architecture 900 describes a computing device for executing the vehicle autonomy system, described herein.

The architecture 900 may operate as a standalone device or may be connected (e.g., networked) to other machines. In a networked deployment, the architecture 900 may operate in the capacity of either a server or a client machine in server-client network environments, or it may act as a peer machine in peer-to-peer (or distributed) network environments. The architecture 900 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 900 includes a processor unit 902 comprising at least one processor (e.g., a central processing unit (CPU), a graphics processing unit (GPU), or both, processor cores, compute nodes). The architecture 900 may further comprise a main memory 904 and a static memory 906, which communicate with each other via a link 908 (e.g., a bus). The architecture 900 can further include a video display unit 910, an input device 912 (e.g., a keyboard), and a user interface (UI) navigation device 914 (e.g., a mouse). In some examples, the video display unit 910, input device 912, and UI navigation device 914 are incorporated into a touchscreen display. The architecture 900 may additionally include a storage device 916 (e.g., a drive unit), a signal generation device 918 (e.g., a speaker), a network interface device 920, and one or more sensors (not shown), such as a GPS sensor, compass, accelerometer, or other sensor.

In some examples, the processor unit 902 or another suitable hardware component may support a hardware interrupt. In response to a hardware interrupt, the processor unit 902 may pause its processing and execute an ISR, for example, as described herein.

The storage device 916 includes a machine-readable medium 922 on which is stored one or more sets of data structures and instructions 924 (e.g., software) embodying or used by any one or more of the methodologies or functions described herein. The instructions 924 can also reside, completely or at least partially, within the main memory 904, within the static memory 906, and/or within the processor unit 902 during execution thereof by the architecture 900, with the main memory 904, the static memory 906, and the processor unit 902 also constituting machine-readable media.

### Executable Instructions and Machine-Storage Medium

The various memories (i.e., 904, 906, and/or memory of the processor unit(s) 902) and/or the storage device 916 may store one or more sets of instructions and data structures (e.g., the instructions 924) embodying or used by any one or more of the methodologies or functions described herein. These instructions, when executed by the processor unit(s) 902, cause various operations to implement the disclosed examples.

As used herein, the terms “machine-storage medium,” “device-storage medium,” and “computer-storage medium” (referred to collectively as “machine-storage medium”) mean the same thing and may be used interchangeably. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 924 can further be transmitted or received over a communications network 926 using a transmission medium via the network interface device 920 using any one of a number of well-known transfer protocols (e.g., Hypertext Transfer Protocol (HTTP)). Examples of communication networks include a local area network (LAN), a wide area network (WAN), the Internet, mobile telephone networks, plain old telephone service (POTS) networks, and wireless data networks (e.g., Wi-Fi, 3G, 4G Long-Term Evolution (LTE)/LTE-A, 5G, or WiMAX networks).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other examples can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as examples can feature a subset of said features. Further, examples can include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

1. A system for controlling a self-driving vehicle, comprising:
at least one processor; and
at least one machine-readable medium comprising instructions thereon that, when executed by the at least one processor, causes the at least one processor to perform operations comprising:
causing the self-driving vehicle to begin traversing a route;
detecting that the self-driving vehicle is approaching an obstruction;
determining to take a deviating maneuver to a revised route prior to the obstruction;
causing the self-driving vehicle to take the deviating maneuver; and
causing the self-driving vehicle to execute a revised route, the revised route including the deviating maneuver.

2. The system of claim 1, wherein the deviating maneuver is towards a target.

3. The system of claim 1, the operations further comprising comparing a time-to-target for the revised route to an updated time-to-target for the route considering the obstruction, wherein the determining to take the deviating maneuver is based at least in part on the comparing.

4. The system of claim 1, wherein the obstruction comprises a traffic signal, the operations further comprising determining that the traffic signal indicates a stop instruction for traffic along a direction of travel of the self-driving vehicle.

5. The system of claim 4, the operations further comprising determining that the traffic signal indicates a go instruction for traffic making the deviating maneuver.

6. The system of claim 4, the operations further comprising:
estimating a first time until the traffic signal indicates a go instruction for traffic along the direction of travel of the self-driving vehicle;
determining an updated time-to-target for the route using the first time; and
determining a time-to-target for a revised route in which the self-driving vehicle takes the deviating maneuver, wherein the determining to take the deviating maneuver is based at least in part on the updated time-to-target for the route and the time-to-target for the revised route.

7. The system of claim 6, the operations further comprising determining a first number of vehicles waiting at the traffic signal along the direction of travel of the self-driving vehicle, wherein the estimating of the first time is based at least in part on the first number of vehicles.

8. The system of claim 7, the operations further comprising determining a second number of vehicles waiting at the traffic signal to make the deviating maneuver, wherein the determining of the time-to-target for the revised route is based at least in part on the second number of vehicles.

9. The system of claim 1, the operations further comprising:
receiving traffic signal schedule data indicating a schedule for a traffic signal on the route;
predicting a first time when the self-driving vehicle will approach the traffic signal; and
predicting a state of the traffic signal at the first time, wherein the determining that the self-driving vehicle is approaching the obstruction is based at least in part on the predicted state of the traffic signal at the first time.

10. A method for routing a self-driving vehicle, the method comprising:
accessing, by a vehicle autonomy system of a self-driving vehicle, route data describing a first route, the route comprising a sequence of roadway segments extending from a route start point to a route end point;
causing, by the vehicle autonomy system, the self-driving vehicle to begin traversing the route;
detecting, by the vehicle autonomy system, that the self-driving vehicle is approaching an obstruction;
determining, by the vehicle autonomy system, to take a deviating maneuver to a revised route prior to the obstruction;
causing, by the vehicle autonomy system, the self-driving vehicle to take the deviating maneuver; and
causing, by the vehicle autonomy system, the self-driving vehicle to execute a revised route to the route end point, the revised route including the deviating maneuver.

11. The method of claim 10, wherein the deviating maneuver is towards a target.

12. The method of claim 10, further comprising comparing a time-to-target for the revised route to an updated time-to-target for the route considering the obstruction, wherein the determining to take the deviating maneuver is based at least in part on the comparing.

13. The method of claim 10, wherein the obstruction comprises a traffic signal, further comprising determining that the traffic signal indicates a stop instruction for traffic along a direction of travel of the self-driving vehicle.

14. The method of claim 13, further comprising determining that the traffic signal indicates a go instruction for traffic making the deviating maneuver.

15. The method of claim 13, further comprising:
estimating a first time until the traffic signal indicates a go instruction for traffic along the direction of travel of the self-driving vehicle;
determining an updated time-to-target for the route using the first time; and
determining a time-to-target for a revised route in which the self-driving vehicle takes the deviating maneuver, wherein the determining to take the deviating maneuver is based at least in part on the updated time-to-target for the route and the time-to-target for the revised route.

16. The method of claim 15, further comprising determining a first number of vehicles waiting at the traffic signal along the direction of travel of the self-driving vehicle, wherein the estimating of the first time is based at least in part on the first number of vehicles.

17. The method of claim 16, further comprising determining a second number of vehicles waiting at the traffic signal to make the deviating maneuver, wherein the determining of the time-to-target for the revised route is based at least in part on the second number of vehicles.

18. The method of claim 10, further comprising:
receiving traffic signal schedule data indicating a schedule for a traffic signal on the route;
predicting a first time when the self-driving vehicle will approach the traffic signal; and
predicting a state of the traffic signal at the first time, wherein the determining that the self-driving vehicle is approaching the obstruction is based at least in part on the predicted state of the traffic signal at the first time.

19. A machine-readable medium comprising instructions thereon that, when executed by at least one processor, causes the at least one processor to perform operations comprising:
accessing route data describing a first route, the route comprising a sequence of roadway segments extending from a route start point to a route end point;
causing a self-driving vehicle to begin traversing the route;
detecting that the self-driving vehicle is approaching an obstruction;
determining to take a deviating maneuver to a revised route prior to the obstruction;
causing the self-driving vehicle to take the deviating maneuver; and
causing the self-driving vehicle to execute a revised route to the route end point, the revised route including the deviating maneuver.

20. The medium of claim 19, the operations further comprising comparing a time-to-target for the revised route to an updated time-to-target for the route considering the obstruction, wherein the determining to take the deviating maneuver is based at least in part on the comparing.
